(19) United States
(12) Patent Application Publication
(10) Pub. No.: US 2025/0086487 A1
(43) Pub. Date: Mar. 13, 2025

(54) SHAPING QUANTUM CHANNELS WITH RANDOM PAULI GATES

(71) Applicant: International Business Machines Corporation, Armonk, NY (US)

(72) Inventor: David Layden, San Jose, CA (US)

(21) Appl. No.: 18/463,899

(22) Filed: Sep. 8, 2023

(51) Int. Cl. G06N 10/40

(52) U.S. Cl. CPC G06N 10/40

(57) ABSTRACT

Systems, computer program products and/or computer-implemented methods described herein relates to in-process error mitigation by shaping quantum channels. A system can comprise a memory that stores computer executable components and a processor that executes the computer executable components, which can comprise a modification component that replaces a first channel of an initial quantum circuit with a second channel that represents the first channel, an insertion component that inserts into the initial quantum circuit a pair of Pauli gates bounding the second channel, resulting in a modified quantum circuit, wherein the pair of Pauli gates are based on Pauli transfer matrix elements of the first channel and the second channel, an execution component that executes the modified quantum circuit at a quantum processor resulting in a measurement outcome that is error mitigated.

### TECHNICAL FIELD

The present disclosure generally relates to a process to provide error reduction for execution of a quantum circuit at a quantum processor, and more particularly to error reduction during the execution of the quantum circuit.

### BACKGROUND

In quantum computing systems execution of a quantum circuit can comprise the application of a series of quantum gates. Due to hardware and/or software aspects, some gates can be applied imperfectly, resulting in measurement outcomes being incorrect and/or having error attributed thereto. In one or more cases, error can be due to experimental imperfections such as miscalibration and/or undesired interactions between the quantum computer and the environment.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to shape a quantum channel with random Pauli gates, execute a resulting quantum circuit, and employ the measurement outcomes of use of a quantum processor to provide error mitigation relative to execution of an original quantum channel having been shaped.

In accordance with an embodiment, a system can comprise a memory that stores computer executable components and a processor that executes the computer executable components stored in the memory. The computer executable components comprise a modification component that replaces a first channel of an initial quantum circuit with a second channel that represents the first channel, an insertion component that inserts into the initial quantum circuit a pair of Pauli gates bounding the second channel, resulting in a modified quantum circuit, wherein the pair of Pauli gates are based on Pauli transfer matrix elements of the first channel and the second channel, and an execution component that executes the modified quantum circuit at a quantum processor resulting in a measurement outcome that is error mitigated.

In accordance with another embodiment, a computer-implemented method can comprise replacing, by a system operatively coupled to a processor, a first channel of an initial quantum circuit with a second channel that represents the first channel, inserting, by the system, into the initial quantum circuit a pair of Pauli gates bounding the second channel, resulting in a modified quantum circuit, wherein the pair of Pauli gates are based on Pauli transfer matrix elements of the first channel and the second channel, and executing, by the system, the modified quantum circuit at a quantum processor resulting in a measurement outcome that is error mitigated.

In accordance with still another embodiment, a computer program product, facilitating a process to provide error mitigation for execution of a quantum circuit, can comprise a computer readable storage medium having program instructions embodied therewith, the program instructions executable by a processor to cause the processor to execute, by the processor, replacing, by the processor, a first channel of an initial quantum circuit with a second channel that represents the first channel, inserting, by the processor, into the initial quantum circuit a pair of Pauli gates bounding the second channel, resulting in a modified quantum circuit, wherein the pair of Pauli gates are based on Pauli transfer matrix elements of the first channel and the second channel, and executing, by the processor, the modified quantum circuit at a quantum processor resulting in a measurement outcome that is error mitigated.

A benefit of the system, computer-implemented method and/or computer program product can be reduction in error of measured outcomes as compared to mere execution of the original quantum channel (e.g., of the first channel of the initial quantum circuit prior to any modification and/or insertion). Indeed, in one or more cases, certain quantum gates simply cannot be applied perfectly on quantum computers in practice. The system, computer-implemented method and/or computer program product can allow for overcoming one or more errors due to experimental imperfections, such as unwanted interactions between the quantum processor and its environment, or miscalibration. Such error also can arise from approximation of a target quantum channel using only a replacement quantum channel. The system, computer-implemented method and/or computer program product can account for one or more of these deficiencies.

Another benefit of the system, computer-implemented method and/or computer program product can be an ability to employ non-Clifford gates, such as partial CNOT gates or partially-entangling R_{ZZ}(θ)=e^{-iθ/2Z⊗Z} gates for arbitrary angles θ. These gates can be employed in a variety of applications, such as simulating quantum dynamics. These gates can be realized on a quantum computer with the realization having higher fidelity than realization of 2-qubit Clifford gates, such as CNOTs, because such non-Clifford gates are shorter than CNOTs. Since the performance of error mitigation (e.g., the sampling overhead) can improve with increasing fidelity, the system, computer-implemented method and/or computer program product can provide a leap in performance by enabling error mitigation on previously inaccessible, native gates.

Yet another benefit of the system, computer-implemented method and/or computer program product can be a reduction in an amount of magic state distillation employed to obtain expectation values, at some cost of additional sampling overhead. That is, some protocols for quantum fault tolerance, Clifford gates can be relatively easy to implement, but non-Clifford gates, such as R_{Z}(θ)=e^{-iθ/2Z} (for arbitrary angles θ) can require a resource-intensive procedure called magic state distillation. However, not all non-Clifford gates are equally difficult. For instance, the cost of implementing R_{Z}(θ) can depend on θ. If desiring to realize R_{Z}(θ₁), but implementing R_{Z}(θ₂) for some nearby angle θ₂≈θ₁ is easier (e.g., takes less time and/or fewer qubits), R_{Z}(θ₁) can be employed as an initial quantum channel modified by the system, computer-implemented method and/or computer program product, with a result of reduction of the amount of magic state distillation employed.

### DESCRIPTION OF THE DRAWINGS

FIG. 1 illustrates a block diagram of an example, non-limiting system that can provide a process to shape a quantum channel and obtain an error mitigated measurement outcome therefrom, in accordance with one or more embodiments described herein.

FIG. 2 illustrates a block diagram of another example, non-limiting system that can provide a process to shape a quantum channel and obtain an error mitigated measurement outcome therefrom, in accordance with one or more embodiments described herein.

FIG. 3 provides an illustration of processes that can be performed by the non-limiting system of FIG. 2, in accordance with one or more embodiments described herein.

FIG. 4 provides an illustration of an initial quantum circuit prior to shaping by the non-limiting system of FIG. 2 and a modified quantum circuit post-shaping by the non-limiting system of FIG. 2, in accordance with one or more embodiments described herein.

FIG. 5 illustrates a non-limiting quantum system that can be employed by the non-limiting system of FIG. 2, in accordance with one or more embodiments described herein.

FIG. 6 illustrates a flow diagram of one or more processes that can be performed by the non-limiting system of FIG. 2, in accordance with one or more embodiments described herein.

FIG. 7 illustrates a continuation of the flow diagram of one or more processes that can be performed by the non-limiting system of FIG. 2, in accordance with one or more embodiments described herein.

FIG. 8 illustrates a flow diagram of one or more processes that can be performed by the non-limiting system of FIG. 2, in accordance with one or more embodiments described herein.

FIG. 9 illustrates a continuation of the flow diagram of FIG. 8 of one or more processes that can be performed by the non-limiting system of FIG. 2, in accordance with one or more embodiments described herein.

FIG. 10 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, many quantum gates cannot be applied perfectly on quantum computers. That is, an administrating entity can desire to perform a selected target gate, described by a quantum channel T, but can only manage to perform a slightly different quantum channel G. On current, pre-fault-tolerant quantum computers, this discrepancy can be mostly due to experimental imperfections, such as unwanted interactions between the quantum computer and its environment, or miscalibration. On future fault-tolerant quantum computers, the discrepancy could also arise from having to approximate a target gate described by T (e.g., a rotation by an arbitrary angle) through a sequence of discrete gates collectively described by G. As used herein, the discrepancy can be described as quantum error.

As used herein, a quantum channel can describe all possible physical operation on a quantum system, which can comprise at least one quantum computer. Mathematically, a quantum channel C can be a completely positive, trace-preserving linear function. The quantum channel C can take a density matrix p as input and return another density matrix ρ′=C(ρ), through operation of a quantum processor. The quantum channel C can describe a unitary operation (e.g., a quantum gate) or any non-unitary operation, such as an imperfect version of a gate that can be performed in available hardware of an available quantum system (e.g., available quantum processor).

The operation of some quantum algorithms, which can be implemented on a quantum system by execution of one or more quantum circuits, can comprise application of a sequence of quantum gates, and then measurement of the expectation value of Pauli matrices based on a result of application of the sequence of quantum gates at a quantum processor. More particularly, such operation of a quantum algorithm can be provided by executing a quantum circuit repeatedly and by subsequently averaging the outcomes until the statistical uncertainty becomes acceptably small (e.g., taking a new average after each one or more additional outcomes). When one or more of the quantum gates are applied imperfectly, as described above, the measured expectation values can be incorrect (e.g., resulting from error due to the imperfect application or due to error causing the imperfect application).

To account for one or more of these deficiencies of existing quantum algorithm operation frameworks, one or more embodiments described herein can provide for recovery of a correct expectation value (associated with a quantum channel T), or an expectation value being more correct than can be obtained using existing quantum algorithm operation frameworks, by implementing a quantum channel G between quasi-randomly selected Pauli gates having appropriate probabilities, performing a scaling process using the measurement outcomes of execution of corresponding quantum circuits at a quantum processor, and averaging the scaled results resulting in a final averaged result. These one or more embodiments can be employed for a broader class of channels T and channels G than was previously possible, such as including when the channel T is not or does not comprise a Clifford gate and when the channel T is or does comprise a Clifford gate. It is noted that the one or more embodiments described herein can employ a greater number of circuit repetitions to achieve a given statistical accuracy of the final averaged result than typically employed if the quantum channel T were able to be applied.

As used herein, the term “Clifford gate” refers to a quantum gate described by unitary matrix U with the property that if P is an n-qubit Pauli, then either UPU^{†} or −UPU^{†} is also an n-qubit Pauli. Clifford gates include all Pauli gates as well as other gates, such as, but not limited to CNOT and CZ gates.

Differently, a “non-Clifford gate” refers to a quantum gate that is not a Clifford gate. Non-Clifford gates include, but are not limited to quantum gates such as R_{Z}(θ)=e^{-iθ/2Z} (for arbitrary angles θ) or partially-entangling R_{ZZ}(θ)=e^{-iθ/2Z⊗Z} gates for arbitrary angles θ.

As used herein, the term “data” can comprise metadata.

As used herein, the terms “entity,” “requesting entity.” and “user entity” can refer to a machine, device, component, hardware, software, smart device, party, organization, individual and/or human.

### DESCRIPTION

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

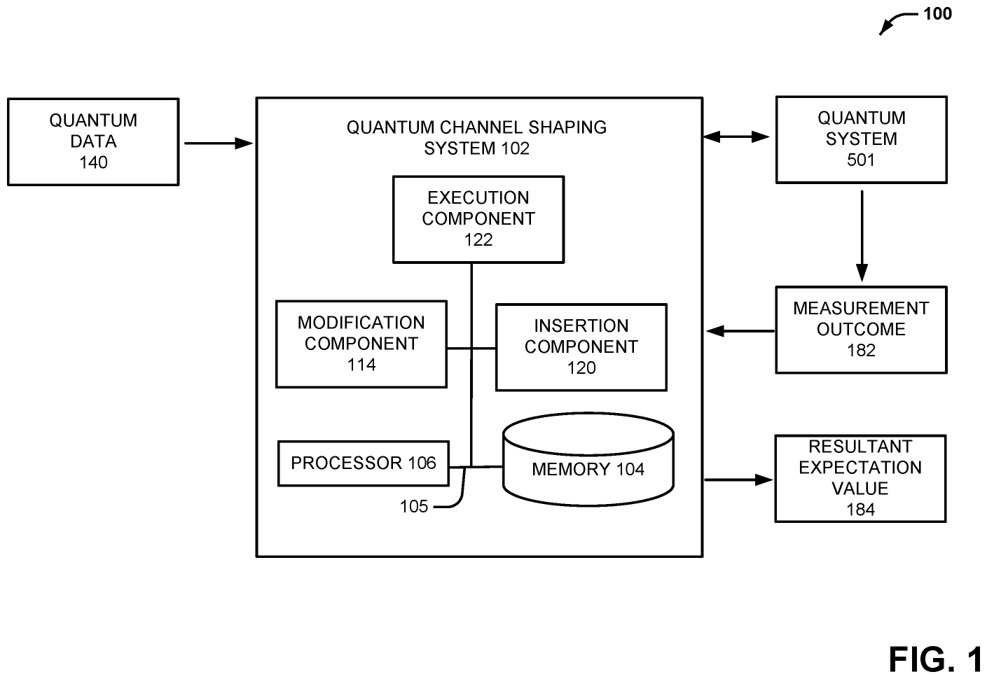

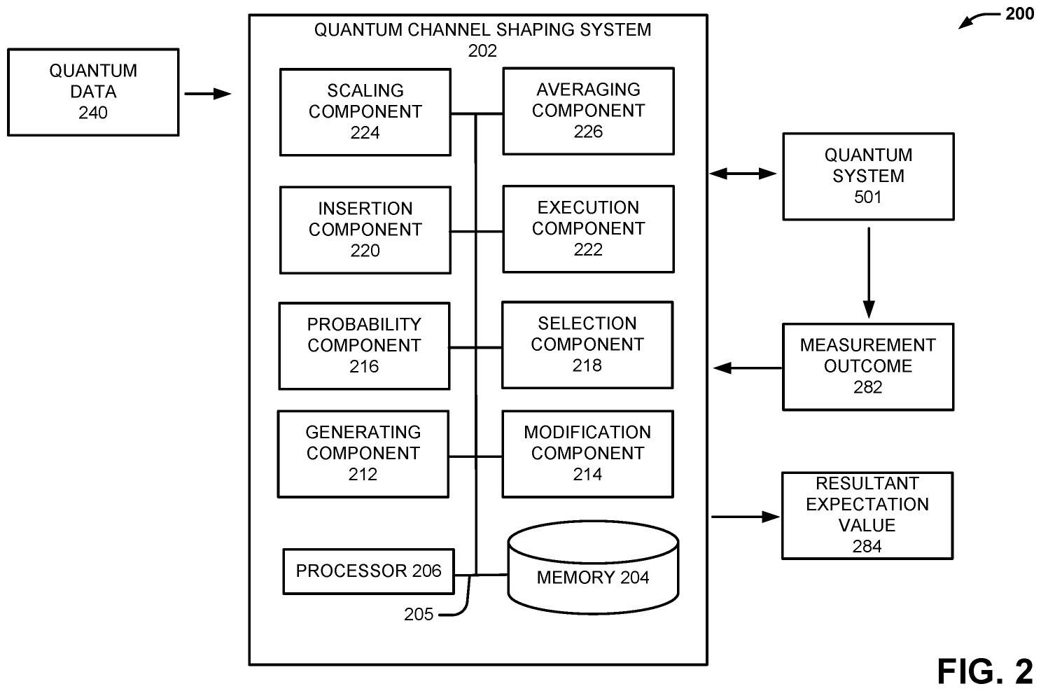

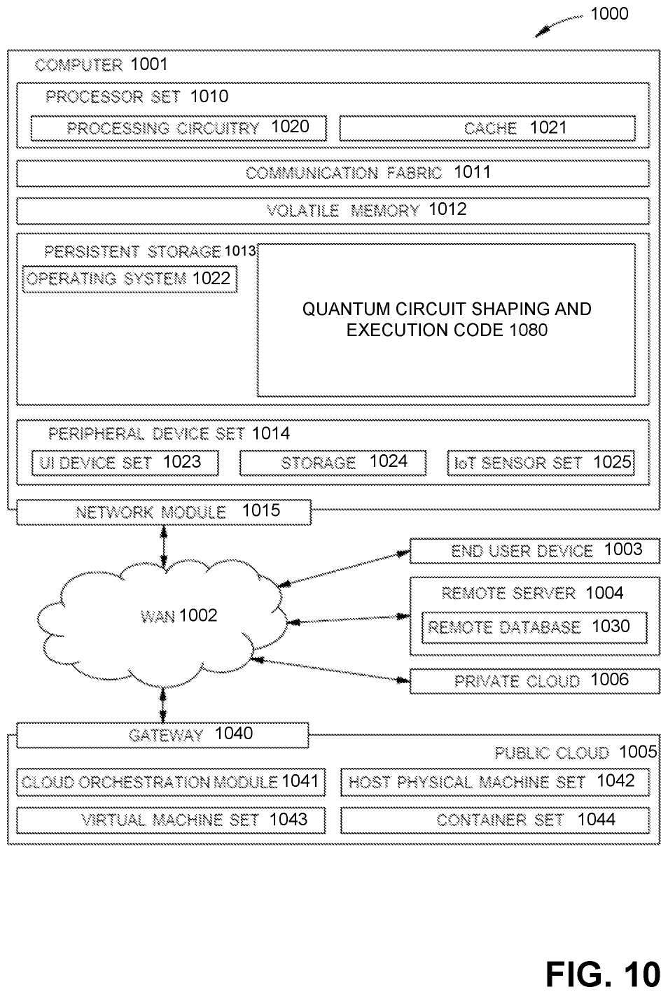

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning now in particular to one or more figures, and first to FIG. 1, the figure illustrates a block diagram of an example, non-limiting system 100 that can facilitate a process to shape a quantum channel and obtain an error mitigated measurement outcome therefrom, in accordance with one or more embodiments described herein. That is, the non-limiting system 100 can facilitate a process to shape and execute a quantum channel such as to provide an error mitigated result based on the quantum channel.

The non-limiting system 100 can comprise a quantum channel shaping system 102. It is noted that the quantum channel shaping system 102 is only briefly detailed to provide but a lead-in to a more complex and/or more expansive quantum channel shaping system 202 as illustrated at FIG. 2. That is, further detail regarding processes that can be performed by one or more embodiments described herein will be provided below relative to the non-limiting system 200 of FIG. 2.

Still referring to FIG. 1, the quantum channel shaping system 102 can comprise at least a memory 104, bus 105, processor 106, modification component 114, insertion component 120 and execution component 122. Using these components and the quantum system 501, the quantum channel shaping system 102 can shape a quantum channel, execute the quantum channel at the quantum system 501, and scale the measurement outcome 182 of the quantum system 501 to obtain a resultant expectation value 184. This resultant expectation value 184 can have a lesser degree of error, and thus can be error mitigated, as compared to use of a non-modified quantum channel and corresponding non-scaled measurement result.

For example, the quantum channel shaping system 102 can obtain a target gate T to execute at a quantum system, such as the quantum system 501. The target gate T can be one that cannot be executed at the quantum system 501, cannot be executed without undesirable error, and/or cannot be executed as quickly as desired, such as due to hardware imperfections, including unwanted interactions with the environment or with other qubits, or due to imperfectly calibrated control operations.

For this reason, the modification component 114 can replace the first channel (e.g., the target gate T) with a second channel that represents the first channel. For example, the second channel, represented as a G channel, can comprise an imperfect implementation of the target gate T. The implementation can be imperfect because of hardware imperfections, including unwanted interactions with the environment or with other qubits, or imperfectly calibrated control operations. As a result of the replacement, a quantum circuit can comprise the G channel in place of the T channel. However, due to the replacement, additional steps can be taken to enable error mitigation of a measurement outcome of implementation of the G channel at the quantum system 501.

For example, based on Pauli transfer matrix elements (to be described in greater detail below relative to FIG. 2) of the first channel and of the second channel, the insertion component 120 can insert a pair of Pauli gates (also to be described in greater detail below relative to FIG. 2) into the initial quantum circuit, resulting in a modified quantum circuit. In particular, a Pauli gate Pⱼ of the pair can be inserted prior to the gᵢⱼ channel, and a Pauli gate Pᵢ of the pair can be inserted after the G channel, where i and j are indices used to label particular elements from the set of n-qubit Paulis represented by the Pauli transfer matrix elements of the Pauli transfer matrix. It is noted that particular steps apply to selection of the pair of Pauli gates, which will be detailed below relative to the quantum channel shaping system 202 of FIG. 2.

It is appreciated that the Pauli gates Pᵢ and Pⱼ can be switched, with adjustment of the definitions of the matrices Q and M, to be described below.

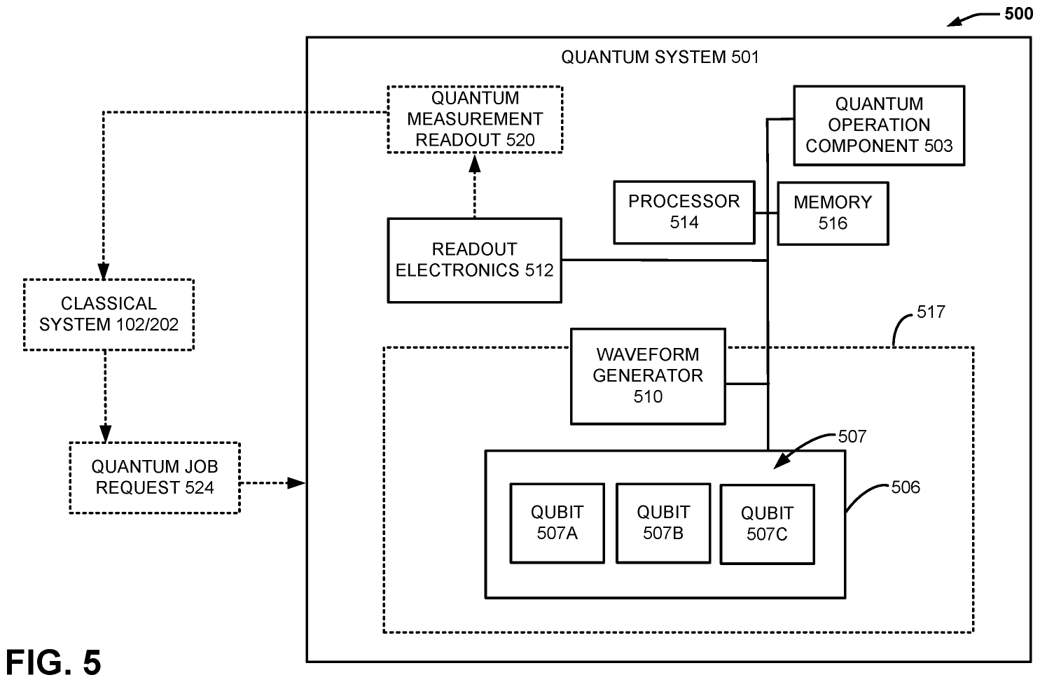

The execution component 122 can execute the modified quantum circuit at a quantum processor, such as of the quantum system 501 by directing the quantum system 501 to execute the modified quantum circuit. For example, the execution component 122 can send a quantum job request 524 (FIG. 5) to the quantum system 501 or can make the quantum job request 524 available to the quantum system 501 for the quantum system 501 to obtain the quantum job request 524. As a result of implementation of the modified quantum circuit by the quantum processor of the quantum system 501, and thus based on one or more measurement readouts from the quantum processor, an expectation value can be obtained by the quantum channel shaping system 102. The expectation value can have reduced error, as compared to execution of the initial circuit prior to the modification (e.g., of the G channel) and insertion (e.g., of the pair of Pauli gates).

It is noted that the modification component 114, the insertion component 120 and the execution component 122 can operate at a classical system of and/or comprising the quantum channel shaping system 102.

In general, the non-limiting system 100 can employ any suitable method of communication (e.g., electronic, communicative, internet, infrared, fiber, etc.) to provide communication between the quantum channel shaping system 102 and the quantum system 501.

Turning next to FIG. 2, a non-limiting system 200 is illustrated that can comprise a quantum channel shaping system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the quantum channel shaping system 202 can shape a quantum channel, execute the quantum channel at the quantum system 501, and scale a measurement outcome 282 of the quantum system 501 to obtain a resultant expectation value 284. This resultant expectation value 284 can have a lesser degree of error, and thus can be error mitigated, as compared to use of a non-modified quantum channel and corresponding non-scaled measurement result.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum channel shaping system 202 can be associated with, such as accessible via, a cloud computing environment.

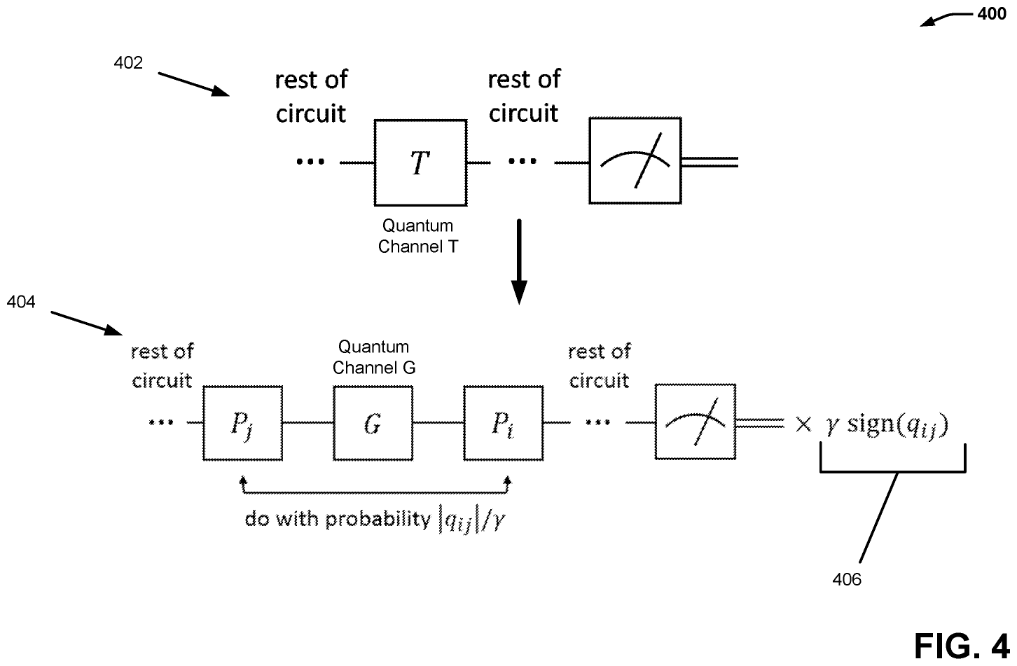

The quantum channel shaping system 202 can comprise a plurality of components. The components can comprise a memory 204, processor 206, bus 205, generating component 212, modification component 214, probability component 216, selection component 218, insertion component 220, execution component 222, scaling component 224 and averaging component 226. Using these components, the quantum channel shaping system 202 can perform the shaping of an initial quantum circuit 402 (FIG. 4) (e.g., comprising a first quantum channel 7), execution of a modified quantum circuit 404 (FIG. 4) (e.g., comprising a second quantum channel G), and scaling of one or more measurement outcomes 282 resulting from the execution to obtain a resultant expectation value 284. As noted above, this resultant expectation value 284 can have a lesser degree of error, and thus can be error mitigated, as compared to use of a non-modified quantum channel and corresponding non-scaled measurement result.

Discussion next turns briefly to the processor 206, memory 204 and bus 205 of the quantum channel shaping system 202. For example, in one or more embodiments, the quantum channel shaping system 202 can comprise the processor 206 (e.g., computer processing unit, microprocessor, classical processor, quantum processor and/or like processor). In one or more embodiments, a component associated with quantum channel shaping system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the generating component 212, modification component 214, probability component 216, selection component 218, insertion component 220, execution component 222, scaling component 224 and averaging component 226.

In one or more embodiments, the quantum channel shaping system 202 can comprise the computer-readable memory 204 that can be operably connected to the processor 206. The memory 204 can store computer-executable instructions that, upon execution by the processor 206, can cause the processor 206 and/or one or more other components of the quantum channel shaping system 202 (e.g., generating component 212, modification component 214, probability component 216, selection component 218, insertion component 220, execution component 222, scaling component 224 and averaging component 226) to perform one or more actions. In one or more embodiments, the memory 204 can store computer-executable components (e.g., generating component 212, modification component 214, probability component 216, selection component 218, insertion component 220, execution component 222, scaling component 224 and averaging component 226).

The quantum channel shaping system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the quantum channel shaping system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum channel shaping system 202 and/or of the non-limiting system 200 can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the quantum channel shaping system 202 and the quantum system 501.

In addition to the processor 206 and/or memory 204 described above, the quantum channel shaping system 202 can comprise one or more computer and/or machine readable, writable and/or executable components and/or instructions that, when executed by processor 206, can provide performance of one or more operations defined by such component and/or instruction.

Discussion next turns to the additional components of the quantum channel shaping system 202 (e.g., generating component 212, modification component 214, probability component 216, selection component 218, insertion component 220, execution component 222, scaling component 224 and averaging component 226).

Turning first to the generating component 212, the generating component 212 can generally identify, search, receive, transfer and/or otherwise obtain input data from one or more databases, online resources, entities and/or information caches. The input information can comprise a set of quantum data 240. This input data can be made available to and/or transmitted to the other components of the quantum channel shaping system 202 (e.g., the modification component 214, probability component 216, etc.)

The set of quantum data 240 can be obtained from classical data, quantum simulation, quantum transducers, etc. The set of quantum data 240 can result from and/or be based on output of the quantum system 501 or of another quantum system. In one or more embodiments, classical data can be transformed into quantum data, such as one or more quantum states, such as by the generating component 212.

Turning briefly to FIG. 4, in one or more embodiments, the generating component 212 can generate an initial quantum circuit 402 (FIG. 4) based on the set of quantum data 240. The initial quantum circuit 402 can comprise a first channel, such as a T channel. The T channel can comprise and/or can be a target gate T that can be one that cannot be executed at the quantum system 501, cannot be executed without undesirable error, and/or cannot be executed as quickly as desired.

For this reason, the modification component 214 can analyze the initial quantum circuit 402 and can replace the first channel (e.g., being and/or comprising the target gate T) with a second channel that represents the first channel. For example, the second channel, represented as a G channel, can comprise an imperfect implementation of the target gate T. The implementation can be imperfect because of hardware imperfections, including unwanted interactions with the environment or with other qubits, or imperfectly calibrated control operations. As a result of the replacement, a partially-modified quantum circuit can comprise the G channel in place of the T channel.

However, due to the replacement, additional steps can be taken to enable error mitigation of a measurement outcome of implementation of the G channel at the quantum system 501.

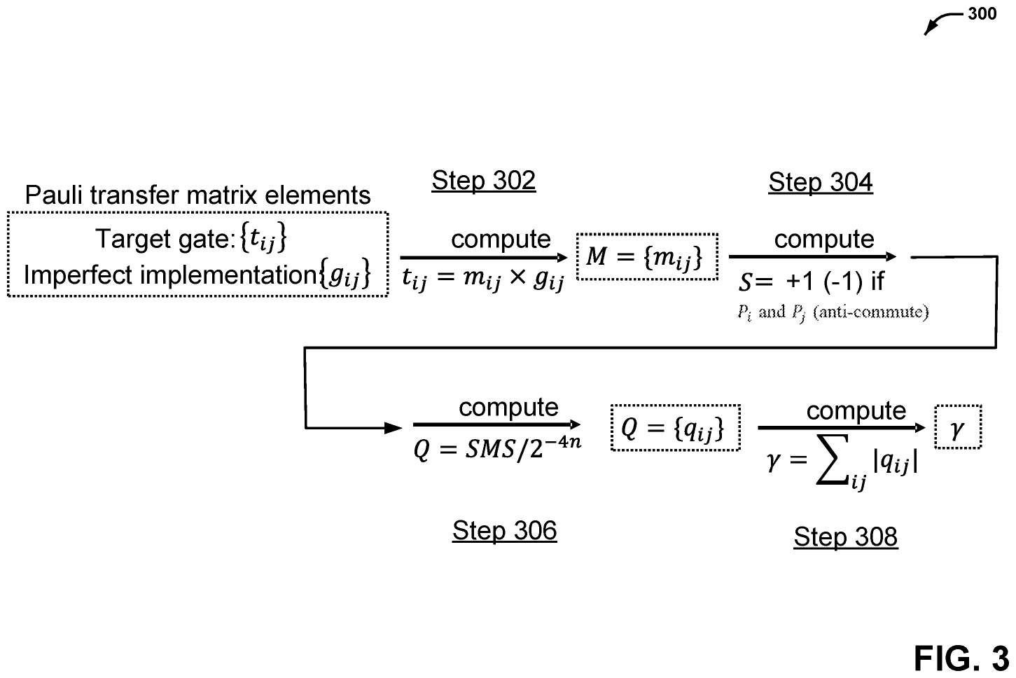

That is, description turns next to FIGS. 3 and 4, in addition to still referring to FIG. 2 and also to the probability component 216, the selection component 218 and the insertion component 220 of the quantum channel shaping system 202. Together, these components can identify, select and insert a pair of Pauli gates bounding the G channel. These processes can be performed for a plurality of iterations of generating and executing of a modified quantum circuit 404. That is, each iteration can comprise a different pair of Pauli gates bounding the same G channel. Multiple iterations can be performed to achieve a desirable statistical level of error of an aggregation of results of the executions of the multiple iterations.

Generally, the individual pair of Pauli gates (Pⱼ and Pᵢ as illustrated at the modified quantum circuit 404 of the quantum circuit schematics 400 of FIG. 4) selected for each iteration of the modified quantum circuit 404 are identified and selected from a set of pairs of Pauli gates by the selection component 218.

Regarding the Pauli gates, X, Y, and Z can be employed to denote Pauli σₓ, σ_{y} and σ_{z} matrices, respectively. An n-qubit Pauli is an n-fold tensor product of 1, X, Y and Z. There are 4ⁿ n-qubit Paulis. Any two n-qubit Paulis P₁ and P₂ either commute (e.g., [P₁, P₂]=P₁P₂−P₂P₁=0) or anti-commute (e.g., {P₁, P₂}=P₁P₂+P₂P₁=0). The n-qubit Paulis can describe quantum gates (an n-qubit Pauli means single-qubit Pauli gates are applied to n qubits in parallel), or measurement operators, the possible outcomes of which are ±1.

To facilitate the selection by the selection component 218, and relative to use of the quantum channel shaping system 202, each pair of Pauli gates can have associated therewith a probability based on Pauli transfer matrix elements of the first channel (T channel) and the second channel (G channel). These probabilities can be determined by the probability component 216 based on the aforementioned Pauli transfer matrix elements, resulting in a set of probabilities that each separately correspond to a pair of the Pauli gates of the set of pairs of Pauli gates.

As used herein, a “Pauli transfer matrix” can be employed to describe a quantum channel C, such as the G channel. Any quantum channel C can be fully described by 4ⁿ×4ⁿ Pauli transfer matrix elements cᵢⱼ=Tr[PᵢC(Pⱼ)]/2ⁿ, where i and j are are indices (e.g., describing height and width of the Pauli transfer matrix from row 1 to row 4ⁿ and column 1 to column 4ⁿ. Thus each i and j as a pair is used to label a particular element from the Pauli transfer matrix elements cᵢⱼ. That is, there are 4ⁿ×4ⁿ pairs of i and j, where each pair of i and j represents two n-qubit Pauli gates of a set of n-qubit Pauli gates represented by the Pauli transfer matrix. For example, a quantum channel C that is a 2-qubit quantum channel can be fully described by 4²×4² Pauli transfer matrix elements (i.e., 256 different Pauli transfer matrix elements) which represent 4²×4² Pauli gates (e.g., 256 different Pauli gates) and 4²×4² corresponding Pauli matrices.

Subsequently, the Pauli transfer matrix elements can be employed to define a distribution of probabilities according to which the selection component 218 can select a pair of Pauli gates (Pᵢ, Pⱼ) for each iteration of the modified quantum circuit 404. For example, a first pair of Pauli gates (Pᵢ, Pⱼ) can have a 0.8% probability and a second pair of Pauli gates (Pᵢ, Pⱼ) can have a 0.002% probability. Accordingly, the first pair of Pauli gates has a 0.8% probability of being selected by the selection component 218 and the second pair of Pauli gates has a 0.002% probability of being selected by the selection component 218.

Discussion turns now to FIG. 3 and to a more detailed explanation of the generation of the probabilities by the probability component 216.

The probability component 216 can perform one or more processes to generate a probability based on Pauli transfer matrix elements of the first channel (tᵢⱼ) and on Pauli transfer matrix elements of the second channel (gᵢⱼ), wherein the pair of Pauli gates for each iteration of the modified quantum circuit 404 are selected by the selection component 218 based on the probability.

For example, referring to FIG. 3 and to the schematic 300, to generate the probabilities corresponding to the quantum channels T and G, the quantum channel shaping system 202 can employ knowledge of the quantum channels T and G in terms of their Pauli transfer matrix elements tᵢⱼ=Tr[PᵢT(Pⱼ)]/2ⁿ and gᵢⱼ=Tr[PᵢG(Pⱼ)]/2ⁿ, such as for 0≤i, j≤4ⁿ−1, respectively. The former (tᵢⱼ) are typically easiest to compute, since T is the gate desired to be performed, while the latter (gᵢⱼ) are measured experimentally using one of many possible techniques, such as quantum process tomography.

The embodiments described herein assume knowledge of the Pauli transfer matrix elements tᵢⱼ and gᵢⱼ. Based on these Pauli transfer matrix elements, the probability component 216 can generate a matrix M having elements mᵢⱼ that all satisfy tᵢⱼ=mᵢⱼ×gᵢⱼ, at step 302. That is, mᵢⱼ=tᵢⱼ/gᵢⱼ wherever gᵢⱼ≠0. If tᵢⱼ=gᵢⱼ=0, then mᵢⱼ can be chosen arbitrarily.

It is noted that if gᵢⱼ=0 but tᵢⱼ≠0, then this method cannot be employed. That is, it is noted that the methods described herein do not apply to quantum channels for which Tr[PᵢT(Pⱼ)]≠0 and Tr[PᵢG(Pⱼ)]=0 for any n-qubit Pauli operators Pᵢ and Pⱼ, where Tr is a trace of a matrix (i.e., the sum of all the diagonal elements).

Referring still to the matrix M, the probability component 216 can generate a quasi-probability matrix Q from the matrix M and a matrix S. That is, the matrix S having elements sᵢⱼ can be also generated by the probability component 216 (e.g., at step 304) with elements sᵢⱼ=+1 if Pᵢ and Pⱼ commute or −1 if Pᵢ and Pⱼ anti-commute. That is, each element of sᵢⱼ can be individually determined based on if a first Pauli gate Pⱼ corresponding to the element sᵢⱼ and a second Pauli gate Pᵢ corresponding to the element sᵢⱼ commute or anti-commute, where the first and second Pauli gates are the pair of Pauli gates corresponding to that element sᵢⱼ.

Based on the matrix M and the matrix S, the quasi-probability matrix Q having elements qᵢⱼ can be defined by the probability component 216 using Equation 1 (e.g., at step 306), and a scale factor γ can be defined by the probability component 216 using Equation 2 (e.g., at step 308).

$$Q = SMS / {2}^{- 4 n} = \{ {q}_{i j} \} . \qquad Equation 1$$

$$γ = {\sum }_{i j} \vert {q}_{i j} \vert . \qquad Equation 2$$

Accordingly, the scale factor γ can be defined as a sum of the absolute values of the elements of the quasi-probability matrix Q that is based on the Pauli transfer matrix elements tᵢⱼ and gᵢⱼ of the first and second quantum channels.

Finally, based on the elements {qᵢⱼ} and on the scale factor γ, the probability for each of the pairs of Pauli gates of a set of all pairs of Pauli gates corresponding to the elements {qᵢⱼ} can be determined based on Equation 3 as being the absolute value of the respective element qᵢⱼ divided by the scale factor γ.

$${probability}_{ij} = \vert {q}_{i j} \vert / γ . \qquad Equation 3$$

The probability for each respective element qᵢⱼ in aggregate can be defined as a probability distribution bounding the selection of the pair of Pauli gates Pⱼ and Pᵢ for each iteration of the modified quantum circuit 404 by the selection component 218.

That is, for each circuit repetition, the selection component 218 can randomly select, within the bounds of the probability distribution defined by the probability component 216, the pair of Pauli gates Pⱼ and Pᵢ from a group of all pairs of Pauli gates Pⱼ and Pᵢ.

Each pair of the group corresponds to a different matrix element qᵢⱼ of the quasi-probability matrix Q. Thus, the number of pairs of Pauli gates Pⱼ and Pᵢ is equal to the number of matrix elements qᵢⱼ of the quasi-probability matrix Q. For example, for the quantum channel G being an n-qubit channel, the number of Pauli transfer matrix elements gᵢⱼ is 4ⁿ×4ⁿ, and thus the number of matrix elements qᵢⱼ of the quasi-probability matrix Q also is 4ⁿ×4ⁿ. Thus, for a 2-qubit channel G, the number of Pauli transfer matrix elements gᵢⱼ is 256, and thus the number of matrix elements qᵢⱼ of the quasi-probability matrix Q is 256.

The insertion component 220 can insert into the initial quantum circuit 402 the pair of Pauli gates Pⱼ and Pᵢ bounding the second channel (the quantum channel G, also referred to as the G channel).

That is, based on Pauli transfer matrix elements of the first channel and of the second channel, the insertion component 220 can insert a pair of Pauli gates into the initial quantum circuit, resulting in a modified quantum circuit. In particular, a Pauli gate Pⱼ of the pair can be inserted by the insertion component 220 prior to the gᵢⱼ channel, and a Pauli gate Pᵢ of the pair can be inserted by the insertion component 220 after the G channel.

As a result of completion of the modified quantum circuit 404, the execution component 222 can execute the modified quantum circuit at a quantum processor 506, such as of the quantum system 501 by directing the quantum system 501 to execute the modified quantum circuit 404. For example, the execution component 222 can send a quantum job request 524 to the quantum system 501 or can make the quantum job request 524 available to the quantum system 501 for the quantum system 501 to obtain the quantum job request 524.

As a result of implementation of the modified quantum circuit 404 by the quantum processor 506 of the quantum system 501, and thus based on one or more measurement readouts 520 from the quantum processor, an expectation value can be obtained by the quantum channel shaping system 202. The expectation value can have reduced error, as compared to execution of the initial quantum circuit 402 prior to the modification (e.g., of the G channel) and insertion (e.g., of the pair of Pauli gates).

It is noted that the modification component 214, the probability component 216, the selection component 218, the insertion component 220 and the execution component 222 can operate at a classical system of and/or comprising the quantum channel shaping system 202.

However, prior to discussion of the determination of the expectation value of each iteration of the modified quantum circuit 404, and prior to the discussion of determination of a resultant expectation value 284 based on a general aggregation of the individual expectation values, direction first turns to function of the quantum system 501. That is, the operation of the quantum system 501 can allow for the output of the quantum measurement readouts 520 and thus allow for the determination of an individual expectation value from each iteration.

That is, turning to FIG. 5, one or more embodiments described herein can include one or more devices, systems and/or apparatuses that can provide a process to generate one or more waveforms for a quantum-based operation (e.g., using a quantum device), such as for operating one or more qubits of a quantum device. Accordingly, at FIG. 5, illustrated is a block diagram of an example, non-limiting system 500 that can at least partially facilitate such a process. While referring here to one or more processes, facilitations and/or uses of the non-limiting system 500, description provided herein, both above and below, also can be relevant to one or more other non-limiting systems described herein, such as the non-limiting systems 100 and/or 200.

As illustrated at FIG. 5, the non-limiting system 500 can comprise a quantum system 501 that can be employed with or separate from the classical systems 102/202.

Generally, the quantum system 501 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 520, can be responsive to the quantum job request 524 and associated input data and can be based at least in part on the input data, quantum functions and/or quantum computations.

In one or more embodiments, the quantum system 501 can comprise components, such as a quantum operation component 503, a quantum processor 506, pulse component 510 (e.g., a waveform generator) and/or a readout electronics 512 (e.g., readout component). In one or more other embodiments, the readout electronics 512 can be comprised at least partially by the classical system 102/202 and/or be external to the quantum system 501. The quantum processor 506 can comprise one or more, such as plural, qubits 507. Individual qubits 507A, 507B and 507C, for example, can be fixed frequency and/or single junction qubits, such as transmon qubits.

In one or more embodiments, a memory 516 and/or processor 514 can be associated with the quantum operation component 503, where suitable. The processor 514 can be any suitable processor. The processor 514 can generate one or more instructions for controlling the one or more processes of the quantum operation component 503.

The quantum operation component 503 can obtain (e.g., download, receive, search for and/or the like) a quantum job request 524 requesting execution of one or more quantum programs and/or a physical qubit layout. The quantum job request 524 can be provided in any suitable format, such as a text format, binary format and/or another suitable format. In one or more embodiments, the quantum job request 524 can be obtained by a component other than of the quantum system 501, such as a by a component of the classical systems 102/202.

The quantum operation component 503 can determine mapping of one or more quantum logic circuits for executing a quantum program. In one or more embodiments, the quantum operation component 503 and/or quantum processor 506 can direct the waveform generator 510 to generate one or more pulses, tones, waveforms and/or the like to affect one or more qubits 507, such as in response to a quantum job request 524.

The waveform generator 510 can generally cause the quantum processor 506 to perform one or more quantum processes, calculations and/or measurements by creating a suitable electro-magnetic signal. For example, the waveform generator 510 can operate one or more qubit effectors, such as qubit oscillators, harmonic oscillators, pulse generators and/or the like to cause one or more pulses to stimulate and/or manipulate the state(s) of the one or more qubits 507 comprised by the quantum system 501.

The quantum processor 506 and a portion or all of the waveform generator 510 can be contained in a cryogenic environment, such as generated by a cryogenic environment 517, such as effected by a dilution refrigerator. Indeed, a signal can be generated by the waveform generator 510 to affect one or more of the plurality of qubits 507. Where the plurality of qubits 507 are superconducting qubits, cryogenic temperatures, such as about 4K or lower, can be employed for function of these physical qubits. Accordingly, one or more elements of the readout electronics 112 also can be constructed to perform at such cryogenic temperatures.

The readout electronics 512, or at least a portion thereof, can be contained in the cryogenic environment 517, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

Turning back to FIGS. 2 and 4, description of one or more processes performed post-quantum execution by the quantum channel shaping system 202 are now described.

For example, the scaling component 224 can, employing the measurement outcome 282 of the execution of the modified quantum circuit 404 from the quantum processor 506, determine an individual expectation value associated with the first channel by scaling the measurement outcome 282.

The scaling of the measurement outcome 282 can comprise multiplying the measurement outcome 282 by the scale factor γ and by a sign of the element qᵢⱼ of elements {qᵢⱼ} of the quasi-probability matrix Q. See, e.g., numerical element 406 of FIG. 4. The result of the scaling can be the individual expectation value.

Based on more than one individual expectation values being determined for more than one iterations of execution of the modified quantum circuit 404, the averaging component 226 can average results of the scaling, resulting in an averaged expectation value associated with the first channel.

This averaging by the averaging component 226 can be performed as suitable, and/or as selected by an administrator entity. For example, the averaging can be performed after each new determination of a new individual expectation value, after a number x of individual expectation values are determined, or based on statistical error associated with a result of the averaging.

Finally, upon a result of the averaging by the averaging component 226 satisfying a statistical error threshold (e.g., selected by an administrator entity), the averaged expectation value can be output as the resultant expectation value 284 for the first channel (e.g., the T channel/the quantum channel T).

Discussion next turns to a mathematical proof of the aforementioned one or more embodiments. That is, starting with an initial state ρ, suppose Pⱼ is applied, then G, then Pᵢ, then measure Pₗ. The resulting expectation value is defined by Equation 4.

$$Tr [ {P}_{l} {P}_{i} G ( {P}_{j} ρ {P}_{j} ) {P}_{i} ] = {\sum }_{k} {a}_{k} Tr [ {\overbrace{{P}_{i} {P}_{l} {P}_{i}}}^{{s}_{li} {P}_{l}} G ( {\overbrace{{P}_{j} {P}_{k} {P}_{j}}}^{{s}_{jk} {P}_{k}} ) ] = {2}^{n} {\sum }_{k} {a}_{k} {s}_{l i} {s}_{j k} {g}_{l k} , \qquad Equation 4$$

where l is an index labelling an arbitrary n-qubit Pauli, k is an index used in a weighted sum of n-qubit Pauli matrices of any quantum state ρ (e.g., a sum that describes an arbitrary quantum state ρ), and Pₗ is used to denote an arbitrary n-qubit Pauli.

Equation 4 employs the definition of gₗₖ, the Pauli transfer matrix elements of G, and the given that any quantum state ρ can be decomposed as ρ=Σₖ aₖ Pₖ for appropriate coefficients {aₖ}. If the outcomes are multiplied by γ sign (qᵢⱼ), the expectation value will instead be

$$γ sign ( {q}_{i j} ) {2}^{n} {\sum }_{k} {a}_{k} {s}_{li} {s}_{jk} {g}_{lk} .$$

Finally, instead running the process described in detail above with probability |qᵢⱼ|/γ, the overall expectation values (over all these random circuits with scaled outcomes) will be

$${2}^{n} {\sum }_{i j k} {\overbrace{\vert {q}_{i j} \vert / γ \times γ sign ( {q}_{i j} )}}^{{q}_{i j}} {a}_{k} {s}_{l i} {s}_{j k} {g}_{l k} = {2}^{n} {\sum }_{k} {a}_{k} {\overbrace{{\sum }_{ij} {s}_{li} {q}_{ij} {s}_{jk}}}^{{m}_{lk}} {g}_{l k} = {2}^{n} {\sum }_{k} {a}_{k} {\overbrace{{m}_{l k} {g}_{l k}}}^{{t}_{lk}} =$$

Tr[PₗT(ρ)]. This outcome relies on the definitions of qᵢⱼ and mₗₖ and the given that S²=2²ⁿl. This is the same individual expectation value obtained from execution of the target gate T at the quantum processor 506 rather than execution of the imperfect implementation G.

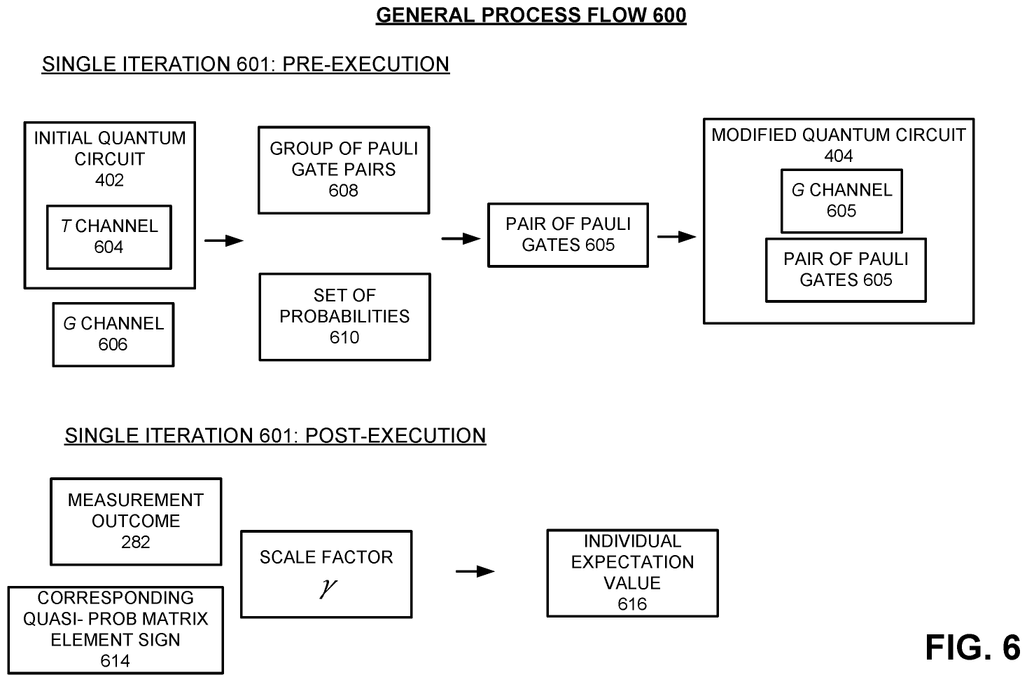

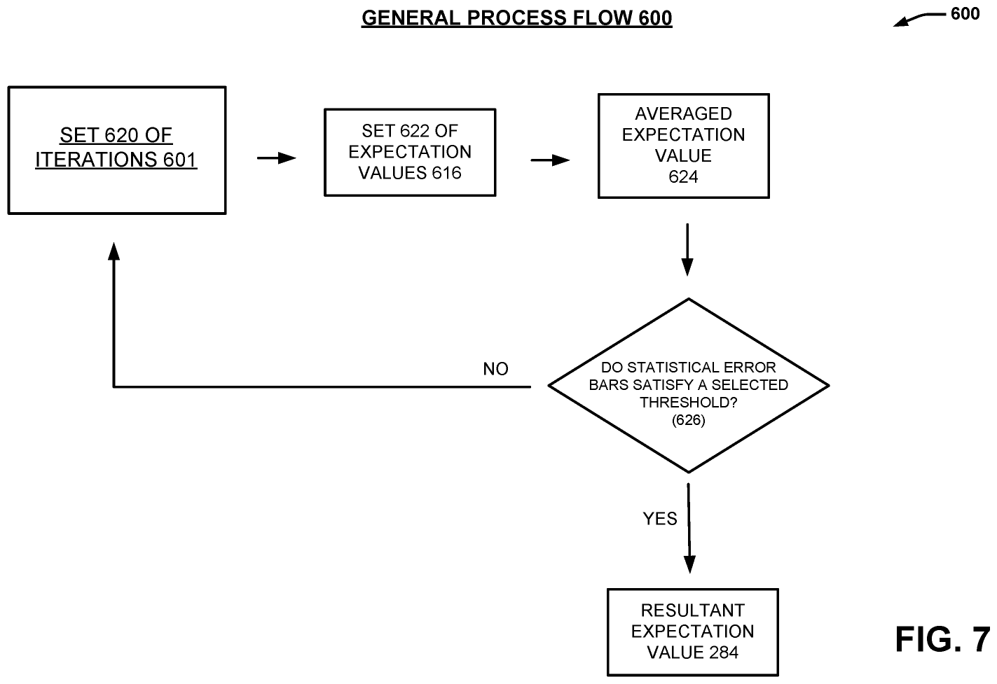

Turning next to FIGS. 6 and 7, illustrated is a general process flow 600 that serves as a summary of the above descriptions of processes that can be performed by the components of the quantum channel shaping system 202.

As illustrated at FIG. 6, a single iteration 601 (pre-execution at the quantum system 501) can comprise use of the T channel 604 and the G channel 606 to determine the group of Pauli gate pairs 608 and the probability distribution (e.g., set of probabilities 610) corresponding thereto by the probability component 216. Based on the probability distribution, the selection component 218 can randomly select, within the probability distribution, a pair of Pauli gates 605 for each separate iteration of the modified quantum circuit 404. Insertion of that pair of Pauli gates 605 by the insertion component can result in the modified quantum circuit 404 which can be executed at the quantum processor 506 by the quantum system 501 at the direction of the execution component 222.

Also as illustrated at FIG. 6, a single iteration 601 (post-execution at the quantum system 501) can comprise use, by the scaling component 224 and averaging component 226 of the corresponding measurement outcome 282 output by the quantum system 501, the scale factor γ output by the probability component 216 and the corresponding quasi-probability matrix element sign 614 (based on the quasi-probability matrix Q generated by the probability component) to output an individual expectation value 616.

As illustrated at FIG. 7, continuing the general process flow 600, but for plural iterations 601, illustrated is the aspect that implementation of a set 620 of the iterations 601 can result in a set 622 of expectation values 616. An averaged expectation value 624 can be output by the averaging component 224 based on implementation of plural iterations 601. The averaging component 224 can perform the decision step 626 by determining whether the statistical error, such as statistical error bars, associated with the averaging component 224, satisfies the selected error threshold. If no, one or more additional iterations 601 can be performed by the quantum channel shaping system 202. If yes, the averaged expectation value 624 can be output as the resultant expectation value 284 by the averaging component 226.

As a result of the aforementioned general process flow 600, in quantum protocols pre-fault tolerance, current error mitigation techniques (e.g., probabilistic error cancellation, or probabilistic error amplification plus zero-noise extrapolation) can be extended to non-Clifford gates. Specifically, error mitigation on partially-entangling R_{ZZ}(θ)=e^{-iθ/2Z⊗Z} gates can be enabled for arbitrary angles θ. These gates can arise in many applications, such as simulating quantum dynamics, and can be realized natively on a quantum computer having higher fidelity than 2-qubit Clifford gates like CNOTs because such gates are shorter. Since the performance of error mitigation (e.g., the sampling overhead) can improve with increasing fidelity, the one or more embodiments described herein can provide a leap in performance over existing techniques by enabling error mitigation on previously inaccessible, native gates.

Separately, in quantum protocols post-fault tolerance, Clifford gates can be easy to implement but non-Clifford gates such as R_{Z}(θ)=e^{-iθ/2Z} (for arbitrary angles θ) can require a resource-intensive procedure called magic state distillation. Briefly, magic state distillation refers to an iterative process for preparing particular quantum states that can be used to enact non-Clifford gates on a fault-tolerant quantum computer.

However, not all non-Clifford gates are equally difficult; for instance, the cost of implementing R_{Z}(θ) can depend on θ. To realize R_{Z}(θ₁), but where implementing R_{Z}(θ₂) for some nearby angle θ₂≈θ₁ is easier, R_{Z}(θ₁) can be employed as T and R_{Z}(θ₂) can be employed as G. In view thereof, the one or more embodiments described above can be employed to reduce the amount of magic state distillation required to get correct expectation values (e.g., those closer to what would result from the implantation of T, where this possible), at the cost of additional sampling overhead. The additional sampling overhead can be employed due to the scaling (e.g., performed by the scaling component 224) necessary due to the implementation of G and the corresponding pair of Pauli gates.

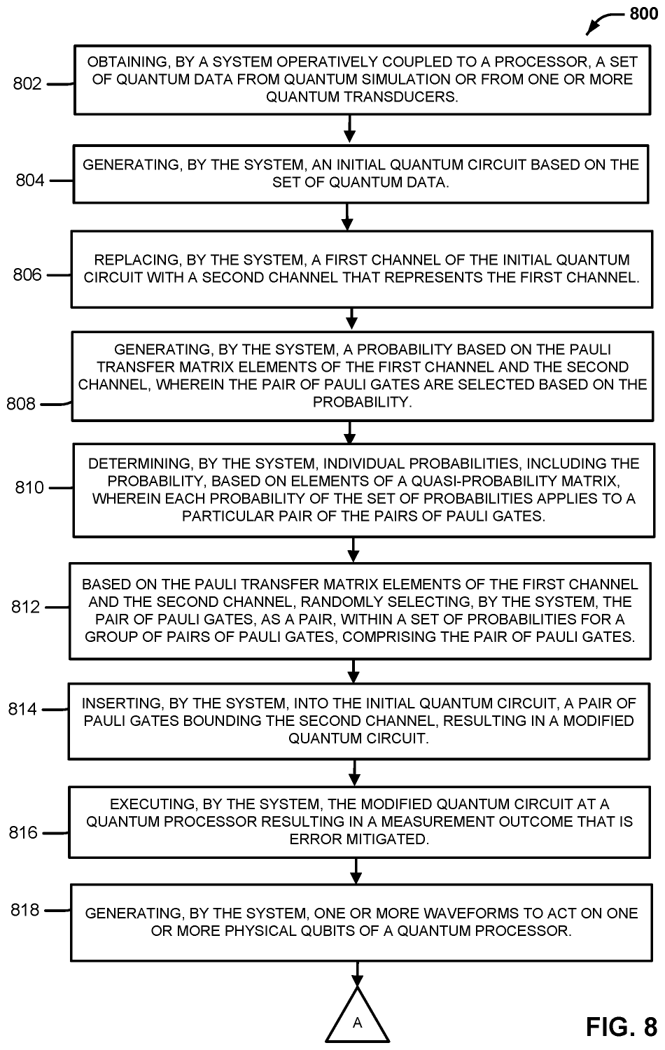

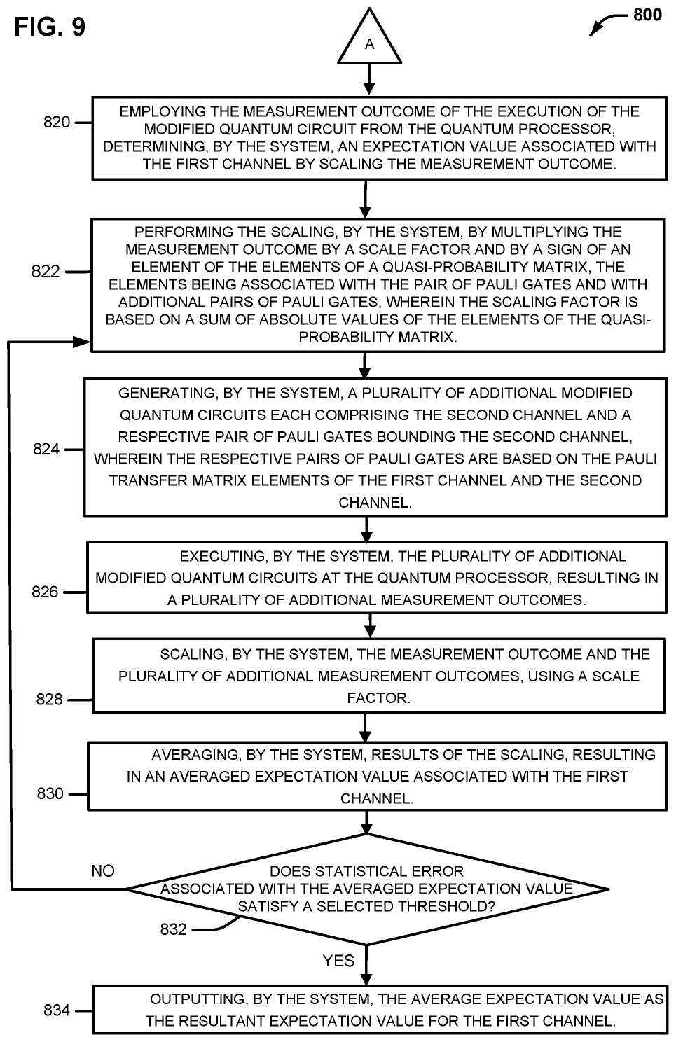

As another summary, referring next to FIGS. 8 and 9, illustrated is a flow diagram of an example, non-limiting method 800 that can provide a process to obtain an error mitigated measurement outcome of operation of a quantum processor, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise obtaining, by a system operatively coupled to a processor (e.g., generating component 212), a set of quantum data (e.g., set of quantum data 240) from quantum simulation or from one or more quantum transducers (e.g., from quantum system 501).

At 804, the non-limiting method 800 can comprise generating, by the system (e.g., generating component 212), an initial quantum circuit (e.g., initial quantum circuit 402), based on the set of quantum data.

At 806, the non-limiting method 800 can comprise replacing, by the system (e.g., modification component 214), a first channel (e.g., quantum channel T) of the initial quantum circuit with a second channel (e.g., quantum channel G) that represents the first channel.

At 808, the non-limiting method 800 can comprise generating, by the system (e.g., probability component 216), a probability (e.g., of a probability distribution 620) based on the Pauli transfer matrix elements (e.g., tᵢⱼ and gᵢⱼ) of the first channel and the second channel, wherein the pair of Pauli gates are selected based on the probability.

At 810, the non-limiting method 800 can comprise determining, by the system (e.g., probability component 216), individual probabilities, including the probability, based on elements (e.g., {gᵢⱼ}) of a quasi-probability matrix (e.g., quasi-probability matrix Q), wherein each probability of the set of probabilities applies to a particular pair of the pairs of Pauli gates (e.g., group of Pauli gate pairs 608).

At 812, the non-limiting method 800 can comprise, based on the Pauli transfer matrix elements of the first channel and the second channel, randomly selecting, by the system (e.g., selection component 218) the pair of Pauli gates, as a pair, within a set of probabilities for a group of pairs of Pauli gates, comprising the pair of Pauli gates.

At 814, the non-limiting method 800 can comprise inserting, by the system (e.g., insertion component 220), into the initial quantum circuit, a pair of Pauli gates (e.g., Pauli gates Pᵢ and Pⱼ) bounding the second channel, resulting in a modified quantum circuit (e.g., modified quantum circuit 404).

At 816, the non-limiting method 800 can comprise executing, by the system (e.g., execution component 222), the modified quantum circuit at a quantum processor resulting in a measurement outcome (e.g., individual measurement outcome 282) that is error mitigated.

At 818, the non-limiting method 800 can comprise, generating, by the system (e.g., waveform generator 510 of the quantum system 501), one or more waveforms to act on one or more physical qubits (e.g., physical qubits 507) of a quantum processor (e.g., quantum processor 506).

In one or more embodiments, the measurement outcome of the execution of the modified quantum circuit from the quantum processor is error mitigated as compared to an execution of the initial quantum circuit prior to replacement of the first channel.

At 820, the non-limiting method 800 can comprise, employing the measurement outcome of the execution of the modified quantum circuit from the quantum processor, determining, by the system (e.g., scaling component 224), an expectation value (e.g., individual expectation value 616) associated with the first channel by scaling the measurement outcome.

At 822, the non-limiting method 800 can comprise performing the scaling, by the system (e.g., scaling component 224), by multiplying the measurement outcome by a scale factor (e.g., scale factor γ) and by a sign of an element (e.g., sign of gᵢⱼ) (e.g., together the numerical element 406) of the elements of a quasi-probability matrix, the elements being associated with the pair of Pauli gates and with additional pairs of Pauli gates, wherein the scaling factor is based on a sum of absolute values of the elements of the quasi-probability matrix.

At 824, the non-limiting method 800 can comprise generating, by the system (e.g., modification component 214, selection component 218 and insertion component 220), a plurality of additional modified quantum circuits each comprising the second channel and a respective pair of Pauli gates bounding the second channel, wherein the respective pairs of Pauli gates are based on the Pauli transfer matrix elements of the first channel and the second channel.

At 826, the non-limiting method 800 can comprise, executing, by the system (e.g., execution component 222), the plurality of additional modified quantum circuits at the quantum processor, resulting in a plurality of additional measurement outcomes.

At 828, the non-limiting method 800 can comprise, scaling, by the system (e.g., scaling component 224), the measurement outcome and the plurality of additional measurement outcomes, using the scale factor.

At 830, the non-limiting method 800 can comprise averaging, by the system (e.g., averaging component 226), results of the scaling, resulting in an averaged expectation value (e.g., averaged expectation value 624) associated with the first channel.

At 832, the non-limiting method 800 can comprise determining, by the system (e.g., averaging component 226), if statistical error associated with the averaged expectation value satisfies a selected threshold.

If yes, the non-limiting method 800 can proceed forward to step 836. If no, the non-limiting method 800 can proceed back to step 824 for one or more additional iterations (e.g., iterations 601).

At 834, the non-limiting method 800 can comprise outputting, by the system (e.g., averaging component 226), the average expectation value as the resultant expectation value (e.g., resultant expectation value 284) for the first channel.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide in-process error mitigation by shaping quantum channels. A system can comprise a memory that stores computer executable components and a processor that executes the computer executable components, which can comprise a modification component that replaces a first channel of an initial quantum circuit with a second channel that represents the first channel, an insertion component that inserts into the initial quantum circuit a pair of Pauli gates bounding the second channel, resulting in a modified quantum circuit, wherein the pair of Pauli gates are based on Pauli transfer matrix elements of the first channel and the second channel, an execution component that executes the modified quantum circuit at a quantum processor resulting in a measurement outcome that is error mitigated.

A benefit of the system, computer-implemented method and/or computer program product can be reduction in error of measured outcomes as compared to mere execution of the original quantum channel (e.g., of the first channel of the initial quantum circuit prior to any modification and/or insertion). Indeed, in one or more cases, certain quantum gates simply cannot be applied perfectly on quantum computers in practice. The system, computer-implemented method and/or computer program product can allow for overcoming one or more errors due to experimental imperfections, such as unwanted interactions between the quantum processor and its environment, or miscalibration. Such error also can arise from approximation of a target quantum channel using only a replacement quantum channel. The system, computer-implemented method and/or computer program product can account for one or more of these deficiencies.

Another benefit of the system, computer-implemented method and/or computer program product can be an ability to employ non-Clifford gates, such as partial CNOT gates or partially-entangling R_{ZZ}(θ)=e^{-iθ/2Z⊗Z} gates for arbitrary angles θ. These gates can be employed in a variety of applications, such as simulating quantum dynamics. These gates can be realized on a quantum computer with the realization having higher fidelity than realization of 2-qubit Clifford gates, such as CNOTs, because such non-Clifford gates are shorter than CNOTs. Since the performance of error mitigation (e.g., the sampling overhead) can improve with increasing fidelity, the system, computer-implemented method and/or computer program product can provide a leap in performance by enabling error mitigation on previously inaccessible, native gates.

Yet another benefit of the system, computer-implemented method and/or computer program product can be a reduction in an amount of magic state distillation employed to obtain expectation values, at some cost of additional sampling overhead. That is, some protocols for quantum fault tolerance, Clifford gates can be relatively easy to implement, but non-Clifford gates, such as R_{Z}(θ)=e^{-iθ/2Z} (for arbitrary angles θ) can require a resource-intensive procedure called magic state distillation. However, not all non-Clifford gates are equally difficult. For instance, the cost of implementing R_{Z}(θ) can depend on θ. If desiring to realize R_{Z}(θ₁), but implementing R_{Z}(θ₂) for some nearby angle θ₂≈θ₁ is easier, R_{Z}(θ₁) can be employed as an initial quantum channel modified by the system, computer-implemented method and/or computer program product, with a result of reduction of the amount of magic state distillation employed.

Indeed, in view of the one or more embodiments described herein, a practical application of the one or more systems, computer-implemented methods and/or computer program products described herein can be the obtaining of error mitigated measurement outcomes from a quantum processor via execution of a quantum circuit shaped by the one or more systems, computer-implemented methods and/or computer program products described herein. Accordingly, measurement outcomes having higher statistical relation to an ideal measurement outcome can be obtained. These processes can be useful in fields of finance, biology, chemistry, materials science, pharmacology and/or drug-delivery using a quantum processor, without being limited thereto. Accordingly, the one or more embodiments described herein provide useful and practical applications of computers, thus providing enhanced (e.g., improved and/or optimized) quantum circuit execution at a quantum processor and enhanced measurement outcomes from the quantum processor. Overall, such computerized tools can constitute a concrete and tangible technical improvement in the fields of quantum processing and/or quantum dynamics, without being limited thereto.

Furthermore, one or more embodiments described herein can be employed in a real-world system based on the disclosed teachings. For example, one or more embodiments described herein can function in combination with a physical quantum computer having a physical quantum processor. In response to one or more waveforms generated by a waveform generator of the quantum computer, physical quantum qubit hardware of the quantum processor can produce signals and/or changes in state of the qubit hardware, resulting in ability to measure such signals and/or changes in state of the qubit hardware. The measurements, e.g., the measurement outcomes, can be thereafter employed for various inference actions relative to sample quantum data corresponding to one or more quantum circuits having been executed on the quantum computer by way of operation of the waveform generator.

Moreover, one or more embodiments described herein can be implemented in one or more domains to enable scaled quantum processing. Indeed, use of a system, computer-implemented method and/or computer program product as described herein can be scalable, such as where plural first quantum channels (e.g., input quantum channels) can be evaluated, processed (e.g., modified) and/or executed at a quantum processor at least partially at a same time as one another. These plural first quantum channels can arise from one or more quantum circuits. Accordingly, scaling can be enabled for more than one quantum circuit at least partially in parallel with one another. These scalings can be made possible by use of independent sets of physical qubits for each first quantum channel. That is, a quantum processor can comprise hardware for plural physical qubits. In view thereof, a qubit mapping can be determined for a single quantum processor for operation of various quantum circuits (e.g., relative to various first quantum channels) at least partially in parallel with one another. Furthermore, the classical processing employed corresponding to the plural first quantum channels also can be performed at least partially in parallel with one another. That is, the processing for modification of quantum circuits and post-measurement outcome scaling can be performed at a classical computer and can be performed relative to plural first quantum channels at least partially in parallel with one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to execution of non-Clifford quantum gates, as compared to existing systems and/or techniques. Systems, computer-implemented methods and/or computer program products providing performance of these processes are of great utility in the fields of quantum circuit operation and/or quantum computing more generally and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically perform quantum circuit encoding, load a quantum register, perform quantum calculations, generate a waveform and/or measure a state of qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: a modification component that replaces a first channel of an initial quantum circuit with a second channel that represents the first channel; an insertion component that inserts into the initial quantum circuit a pair of Pauli gates bounding the second channel, resulting in a modified quantum circuit, wherein the pair of Pauli gates are based on Pauli transfer matrix elements of the first channel and the second channel; and an execution component that executes the modified quantum circuit at a quantum processor resulting in a measurement outcome that is error mitigated.

The system of the preceding paragraph, wherein the measurement outcome of the execution of the modified quantum circuit from the quantum processor is error mitigated as compared to an execution of the initial quantum circuit prior to replacement of the first channel.

The system of any preceding paragraph, further comprising: a probability component that generates a probability based on the Pauli transfer matrix elements of the first channel and the second channel, wherein the pair of Pauli gates are selected based on the probability.

The system of any preceding paragraph, further comprising: a selection component that, based on the Pauli transfer matrix elements of the first channel and the second channel, randomly selects the pair of Pauli gates, as a pair, within a set of probabilities for a group of pairs of Pauli gates, comprising the pair of Pauli gates.

The system of any preceding paragraph, wherein the set of probabilities are individually based on elements of a quasi-probability matrix, and wherein each probability of the set of probabilities applies to a particular pair of the pairs of Pauli gates.

The system any preceding paragraph, further comprising: a scaling component that, employing the measurement outcome of the execution of the modified quantum circuit from the quantum processor, determines an expectation value associated with the first channel by scaling the measurement outcome.

The system of any preceding paragraph, wherein the scaling of the measurement outcome comprises multiplying the measurement outcome by a scale factor and by a sign of an element of elements of a quasi-probability matrix, the elements being associated with the pair of Pauli gates and with additional pairs of Pauli gates, wherein the scaling factor is based on a sum of absolute values of the elements of the quasi-probability matrix.

The system of any preceding paragraph, wherein the modification component and insertion component further generate a plurality of additional modified quantum circuits each comprising the second channel and a respective pair of Pauli gates bounding the second channel, wherein the respective pairs of Pauli gates are based on the Pauli transfer matrix elements of the first channel and the second channel; the execution component further executes the plurality of additional modified quantum circuits at the quantum processor, resulting in a plurality of additional measurement outcomes; and further comprising: a scaling component that scales the measurement outcome and the plurality of additional measurement outcomes, using a scale factor based on a sum of absolute values of elements of a quasi-probability matrix; and an averaging component that averages results of the scaling, resulting in an averaged expectation value associated with the first channel.

A computer-implemented method, comprising: replacing, by a system operatively coupled to a processor, a first channel of an initial quantum circuit with a second channel that represents the first channel; inserting, by the system, into the initial quantum circuit a pair of Pauli gates bounding the second channel, resulting in a modified quantum circuit, wherein the pair of Pauli gates are based on Pauli transfer matrix elements of the first channel and the second channel; and executing, by the system, the modified quantum circuit at a quantum processor resulting in a measurement outcome that is error mitigated.

The computer-implemented method of the preceding paragraph, wherein the measurement outcome of the execution of the modified quantum circuit from the quantum processor is error mitigated as compared to an execution of the initial quantum circuit prior to replacement of the first channel.

The computer-implemented method of any preceding paragraph, further comprising: generating, by the system, a probability associated with the second channel and based on the Pauli transfer matrix elements of the first channel and second channel, wherein the pair of Pauli gates are based on the probability.

The computer-implemented method of any preceding paragraph, further comprising: based on the Pauli transfer matrix elements of the first channel and the second channel, randomly selecting, by the system, the pair of Pauli gates, as a pair, within a set of probabilities for a group of pairs of Pauli gates, comprising the pair of Pauli gates.

The computer-implemented method of any preceding paragraph, further comprising: employing the measurement outcome of the execution of the modified quantum circuit from the quantum processor, determining, by the system, an expectation value associated with the first channel by scaling the measurement outcome; and scaling the measurement outcome, by the system, by multiplying the measurement outcome by a scale factor and by a sign of an element of elements of a quasi-probability matrix, the elements being associated with the pair of Pauli gates and with additional pairs of Pauli gates, wherein the scaling factor is based on a sum of absolute values of the elements of the quasi-probability matrix.

The computer-implemented method of any preceding paragraph, further comprising: generating, by the system, a plurality of additional modified quantum circuits each comprising the second channel and a respective pair of Pauli gates bounding the second channel and based on Pauli transfer matrix elements of the first channel and the second channel; determining, by the system, a plurality of additional measurement outcomes from execution of the plurality of additional quantum circuits at the quantum processor; scaling, by the system, the measurement outcome and the plurality of additional measurement outcomes, using a scale factor based on a sum of absolute values of elements of a quasi-probability matrix; and averaging, by the system, results of the scaling, resulting in an averaged expectation value associated with the first channel.

A computer program product facilitating a process to provide error mitigation for execution of a quantum circuit, the computer program product comprising a computer readable storage medium having program instructions embodied therewith, the program instructions executable by a processor to cause the processor to: replace, by the processor, a first channel of an initial quantum circuit with a second channel that represents the first channel; insert, by the processor, into the initial quantum circuit a pair of Pauli gates bounding the second channel, resulting in a modified quantum circuit, wherein the pair of Pauli gates are based on Pauli transfer matrix elements of the first channel and the second channel; and execute, by the processor, the modified quantum circuit at a quantum processor resulting in a measurement outcome that is error mitigated.

The computer program product of the preceding paragraph, wherein the measurement outcome of the execution of the modified quantum circuit from the quantum processor is error mitigated as compared to an execution of the initial quantum circuit prior to replacement of the first channel.

The computer program product of any preceding paragraph, wherein the program instructions are further executable by the processor to cause the processor to: generate, by the processor, a probability associated with the second channel and based on the Pauli transfer matrix elements of the first channel and second channel, wherein the pair of Pauli gates are based on the probability.

The computer program product of any preceding paragraph, wherein the program instructions are further executable by the processor to cause the processor to: based on the Pauli transfer matrix elements of the first channel and the second channel, randomly select, by the processor, the pair of Pauli gates within a set of probabilities for a group of pairs of Pauli gates, comprising the pair of Pauli gates.

The computer program product of any preceding paragraph, wherein the program instructions are further executable by the processor to cause the processor to: employing the measurement outcome of the execution of the modified quantum circuit from the quantum processor, determine, by the processor, an expectation value associated with the first channel by scaling the measurement outcome; and scale the measurement outcome, by the processor, by multiplying the measurement outcome by a scale factor and by a sign of an element of elements of a quasi-probability matrix, the elements being associated with the pair of Pauli gates and with additional pairs of Pauli gates, wherein the scaling factor is based on a sum of absolute values of the elements of the quasi-probability matrix.

The computer program product of any preceding paragraph, wherein the program instructions are further executable by the processor to cause the processor to: generate, by the processor, a plurality of additional modified quantum circuits each comprising the second channel and a respective pair of Pauli gates bounding the second channel and based on Pauli transfer matrix elements of the first channel and the second channel; determine, by the processor, a plurality of additional measurement outcomes from execution of the plurality of additional quantum circuits at the quantum processor; scale, by the processor, the measurement outcome and the plurality of additional measurement outcomes, using a scale factor based on a sum of absolute values of elements of a quasi-probability matrix; and average, by the processor, results of the scaling, resulting in an averaged expectation value associated with the first channel.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the quantum circuit shaping and execution code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a modification component that replaces a first channel of an initial quantum circuit with a second channel that represents the first channel;
an insertion component that inserts into the initial quantum circuit a pair of Pauli gates bounding the second channel, resulting in a modified quantum circuit,
wherein the pair of Pauli gates are based on Pauli transfer matrix elements of the first channel and the second channel; and
an execution component that executes the modified quantum circuit at a quantum processor resulting in a measurement outcome that is error mitigated.

2. The system of claim 1, wherein the measurement outcome of the execution of the modified quantum circuit from the quantum processor is error mitigated as compared to an execution of the initial quantum circuit prior to replacement of the first channel.

3. The system of claim 1, further comprising:
a probability component that generates a probability based on the Pauli transfer matrix elements of the first channel and the second channel, wherein the pair of Pauli gates are selected based on the probability.

4. The system of claim 1, further comprising:
a selection component that, based on the Pauli transfer matrix elements of the first channel and the second channel, randomly selects the pair of Pauli gates, as a pair, within a set of probabilities for a group of pairs of Pauli gates, comprising the pair of Pauli gates.

5. The system of claim 4, wherein the set of probabilities are individually based on elements of a quasi-probability matrix, and wherein each probability of the set of probabilities applies to a particular pair of the pairs of Pauli gates.

6. The system of claim 1, further comprising:
a scaling component that, employing the measurement outcome of the execution of the modified quantum circuit from the quantum processor, determines an expectation value associated with the first channel by scaling the measurement outcome.

7. The system of claim 6, wherein the scaling of the measurement outcome comprises multiplying the measurement outcome by a scale factor and by a sign of an element of elements of a quasi-probability matrix, the elements being associated with the pair of Pauli gates and with additional pairs of Pauli gates,
wherein the scaling factor is based on a sum of absolute values of the elements of the quasi-probability matrix.

8. The system of claim 1, wherein
the modification component and insertion component further generate a plurality of additional modified quantum circuits each comprising the second channel and a respective pair of Pauli gates bounding the second channel,
wherein the respective pairs of Pauli gates are based on the Pauli transfer matrix elements of the first channel and the second channel;
the execution component further executes the plurality of additional modified quantum circuits at the quantum processor, resulting in a plurality of additional measurement outcomes; and
further comprising:
a scaling component that scales the measurement outcome and the plurality of additional measurement outcomes, using a scale factor based on a sum of absolute values of elements of a quasi-probability matrix; and
an averaging component that averages results of the scaling, resulting in an averaged expectation value associated with the first channel.

9. A computer-implemented method, comprising:
replacing, by a system operatively coupled to a processor, a first channel of an initial quantum circuit with a second channel that represents the first channel;
inserting, by the system, into the initial quantum circuit a pair of Pauli gates bounding the second channel, resulting in a modified quantum circuit,
wherein the pair of Pauli gates are based on Pauli transfer matrix elements of the first channel and the second channel; and
executing, by the system, the modified quantum circuit at a quantum processor resulting in a measurement outcome that is error mitigated.

10. The computer-implemented method of claim 9, wherein the measurement outcome of the execution of the modified quantum circuit from the quantum processor is error mitigated as compared to an execution of the initial quantum circuit prior to replacement of the first channel.

11. The computer-implemented method of claim 9, further comprising:
generating, by the system, a probability associated with the second channel and based on the Pauli transfer matrix elements of the first channel and second channel, wherein the pair of Pauli gates are based on the probability.

12. The computer-implemented method of claim 9, further comprising:
based on the Pauli transfer matrix elements of the first channel and the second channel, randomly selecting, by the system, the pair of Pauli gates, as a pair, within a set of probabilities for a group of pairs of Pauli gates, comprising the pair of Pauli gates.

13. The computer-implemented method of claim 9, further comprising:
employing the measurement outcome of the execution of the modified quantum circuit from the quantum processor, determining, by the system, an expectation value associated with the first channel by scaling the measurement outcome; and
scaling the measurement outcome, by the system, by multiplying the measurement outcome by a scale factor and by a sign of an element of elements of a quasi-probability matrix, the elements being associated with the pair of Pauli gates and with additional pairs of Pauli gates,
wherein the scaling factor is based on a sum of absolute values of the elements of the quasi-probability matrix.

14. The computer-implemented method of claim 9, further comprising:
generating, by the system, a plurality of additional modified quantum circuits each comprising the second channel and a respective pair of Pauli gates bounding the second channel and based on Pauli transfer matrix elements of the first channel and the second channel;
determining, by the system, a plurality of additional measurement outcomes from execution of the plurality of additional quantum circuits at the quantum processor;
scaling, by the system, the measurement outcome and the plurality of additional measurement outcomes, using a scale factor based on a sum of absolute values of elements of a quasi-probability matrix; and
averaging, by the system, results of the scaling, resulting in an averaged expectation value associated with the first channel.

15. A computer program product facilitating a process to provide error mitigation for execution of a quantum circuit, the computer program product comprising a computer readable storage medium having program instructions embodied therewith, the program instructions executable by a processor to cause the processor to:
replace, by the processor, a first channel of an initial quantum circuit with a second channel that represents the first channel;
insert, by the processor, into the initial quantum circuit a pair of Pauli gates bounding the second channel, resulting in a modified quantum circuit,
wherein the pair of Pauli gates are based on Pauli transfer matrix elements of the first channel and the second channel; and
execute, by the processor, the modified quantum circuit at a quantum processor resulting in a measurement outcome that is error mitigated.

16. The computer program product of claim 15, wherein the measurement outcome of the execution of the modified quantum circuit from the quantum processor is error mitigated as compared to an execution of the initial quantum circuit prior to replacement of the first channel.

17. The computer program product of claim 15, wherein the program instructions are further executable by the processor to cause the processor to:
generate, by the processor, a probability associated with the second channel and based on the Pauli transfer matrix elements of the first channel and second channel, wherein the pair of Pauli gates are based on the probability.

18. The computer program product of claim 15, wherein the program instructions are further executable by the processor to cause the processor to:
based on the Pauli transfer matrix elements of the first channel and the second channel, randomly select, by the processor, the pair of Pauli gates, as a pair, within a set of probabilities for a group of pairs of Pauli gates, comprising the pair of Pauli gates.

19. The computer program product of claim 15, wherein the program instructions are further executable by the processor to cause the processor to:
employing the measurement outcome of the execution of the modified quantum circuit from the quantum processor, determine, by the processor, an expectation value associated with the first channel by scaling the measurement outcome; and
scale the measurement outcome, by the processor, by multiplying the measurement outcome by a scale factor and by a sign of an element of elements of a quasi-probability matrix, the elements being associated with the pair of Pauli gates and with additional pairs of Pauli gates,
wherein the scaling factor is based on a sum of absolute values of the elements of the quasi-probability matrix.

20. The computer program product of claim 15, wherein the program instructions are further executable by the processor to cause the processor to:
generate, by the processor, a plurality of additional modified quantum circuits each comprising the second channel and a respective pair of Pauli gates bounding the second channel and based on Pauli transfer matrix elements of the first channel and the second channel;
determine, by the processor, a plurality of additional measurement outcomes from execution of the plurality of additional quantum circuits at the quantum processor;
scale, by the processor, the measurement outcome and the plurality of additional measurement outcomes, using a scale factor based on a sum of absolute values of elements of a quasi-probability matrix; and
average, by the processor, results of the scaling, resulting in an averaged expectation value associated with the first channel.
